(19) United States
(12) Patent Application Publication
(10) Pub. No.: US 2002/0010720 A1
(43) Pub. Date: Jan. 24, 2002

(54) HYPER-TEXT DOCUMENT FORMATTING COLLATING AND PRINTING

(76) Inventors: TIMOTHY MERRICK LONG, LINDFIELD (AU); JAMES ROBERT METCALFE, COLLAROY PLATEAU (AU)

Correspondence Address: FITZPATRICK CELLA HARPER & SCINTO, 30 ROCKEFELLER PLAZA, NEW YORK, NY, 10112, US

(21) Appl. No.: 08/903,743

(22) Filed: Jul. 31, 1997

(51) Int. Cl. G06F 15/00

(52) U.S. Cl. 707/527; 707/909

(57) ABSTRACT

Disclosed is a method and apparatus for formatting, collating and printing, on an output print device, hyper-text documents in a format favoring a printed document The method includes: (a) monitoring a user's access pattern to said hyper-text documents; (b) accessing said hyper-text documents including structure information of the accessed hyper-text documents; (c) creating a formatted version of the accessed hyper-text documents for said user. Preferably the documents are “harvested” of fetched from various hyper-links, in a background mode while a user is accessing various hyper-text documents.

### FIELD OF INVENTION

The present invention relates to hyper-text documents and, in particular, to the network access, formatting and printing of hyper text documents.

### BACKGROUND OF THE INVENTION

Many computer based document mark-up languages have been developed in order to allow computer-aided document preparation. Examples of such language include TROFF, TeX, RTF, as well as many proprietary formats associated with computer hosted word processing applications. These mark-up languages are designed to allow the computer assisted preparation of a document destined for printing. As a consequence to these developments, the prevalence and active nature of digital computers has encouraged the introduction of hyper-links in documents.

A hyper-link is a pointer, typically embedded in a document that provides a direct link to another portion of the same document, another document, another resource available on the current network node or another network node. Hyper-links are often used on the Internet, and in particular the World Wide Web to link a document at one Web site with a document at another Web site.

Hyper-links are only operational when a document is viewed on-line, and not when the document is in printed form. The increased value of these on-line hyper-text documents has caused a weakening of the previous focus on printing. New generation languages used to interpret hyper-text linked documents such as SGMI and HTML (Hyper-Text Mark-up Language), have few features to support the description of their printed form. More importantly, because the principle value of hyper-text documents is for on-line viewing, these documents are formatted by their authors in a manner which is appropriate for screen viewing, and not necessarily for viewing in printed form.

As a result it is now the case that very large quantities of information are recorded in network accessed on-line services in formats which are appropriate for screen based viewing, but not as appropriate for viewing in printed form. Further, because printing is not a focus of applications which access these hyper-text documents (that is, hyper-text browser applications), their printing facilities are generally poor.

Common problems encountered when printing hyper-text documents include:

information is broken up into small hyper-text documents, and many documents need to be collated to form a desired body of information;

text is formatted with fewer words per line than is common for printed pages, and in general the density of information is less than is typical for printed pages;

hyper-text document viewing programs are document-centric, that is they operate on a single hyper-text document at a time, which results in this being the unit of printing, resulting in much repetitive work by the user to print a set of linked hyper-text documents, and typically no more than one hyper-text document on each printed page;

hyper-text document viewing programs generally do not print all the features of hyper-text pages which are displayed on-screen (a display device), in particular the target of hyper-links is often not included in printouts.

It is possible for the provider of a hyper-text document designed for screen viewing to also provide substantially the same documents in a different form designed for printing, but this requires double handling by the document provider. It also often results in significant differences between the screen version of the document and the printed form.

The problem of no more than one hyper-text document per printed page can sometimes be addressed by the reduction and rotation of the image of each basic page and printing each reduced page image on, say, one half of a printed page. However this method does not save paper at a given scale. For example, if a large number of small hyper-text documents are printed, each of which only occupies 25% of a printed (physical) page, even though the documents are photo-reduced and printed two per physical page, each physical page still has 75% blank space. Further, this method does not provide continuous page-length columns. Continuous column printing provides improved readability and space utilization.

An object of the invention is to substantially overcome at least one of the aforementioned problems in the formatting of hyper-text documents.

### SUMMARY OF THE INVENTION

In accordance with one aspect of the present invention there is provided a method of collating hyper-text documents comprising the steps of:

(a) monitoring a user's access patterns to said hyper-text documents;

(b) accessing said hyper-text document including structure information of the accessed hyper-text document;

(c) creating a formatted version of the accessed hyper-text documents for said user.

In accordance with another aspect of the present invention there is provided a method of collating hyper-text documents comprising steps of:

(a) accessing said hyper-text documents including structure information;

(b) creating a formatted version of said accessed hyper-text documents wherein said formatted version is characterised by a single or multiple column printing such that each printed page contains as many of said hyper-text documents as can reasonably fit in an available space on a printed page.

Other aspects and features of the present invention are also disclosed.

### BRIEF DESCRIPTION OF THE DRAWINGS

A preferred embodiment of the present invention will now be described with reference to the accompanying drawings in which:

FIG. 1 is a block diagram showing the operating environment of the preferred embodiment of the present invention;

FIG. 2 shows the visual appearance of a user interface in accordance with the preferred embodiment;

FIG. 3 is a block drawing of an internal structure of the preferred embodiment of the invention;

FIG. 4 is a block diagram of a general purpose computer upon which the preferred embodiment of the present invention can be practiced;

FIG. 5 is an example of the display screen during hyper-text document preparation; and

FIG. 6 is a flowchart depicting operation of a hyper-text document formatting portion of the preferred embodiment.

### DESCRIPTION OF THE PREFERRED EMBODIMENT

The preferred embodiment of the present invention is described as a computer application program hosted on the Windows™ operating system developed by Microsoft Corporation. However, those skilled in the art will recognise that the described embodiment may can be implemented on computer systems hosted by other operating systems. For example, the preferred embodiment can be performed on computer systems running UNIX™, OS/2™, DOS™. The application program has a user interface which includes menu items and controls that respond to mouse and keyboard operations. The application program has the ability to transmit data to one or more printers either directly connected to a host computer or accessed over a network. The application program also has the ability to transmit and receive data to a connected digital communications network (for example the “Internet”).

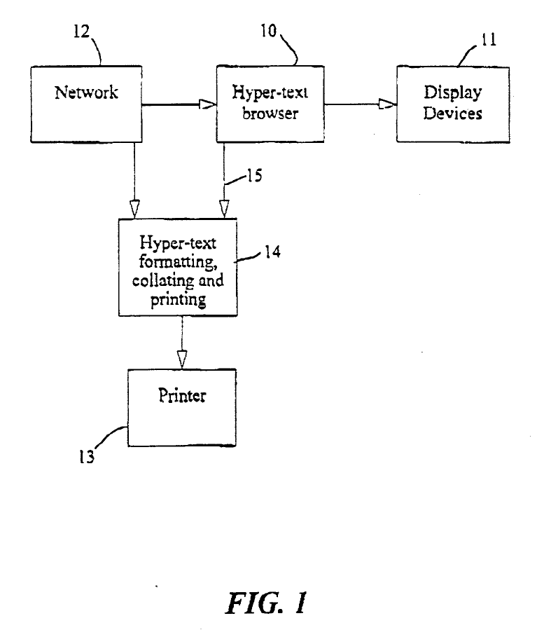

A high-level block diagram is illustrated in FIG. 1 to provide an overview of the preferred embodiment. A hyper-text browser 10 is provided to output to a display device 11 for viewing hyper-text documents. Typically, the hyper-text browser 10 is of the form of application software implemented on a general purpose computer system (eg. IBM PC or compatible, Apple Macintosh, Sun-Workstation etc.) and hyper-text documents include images, linked documents and simple TEXT documents. Current examples of the hyper-text browser include Microsoft Explorer and NETSCAPE. The computer system (not shown in FIG. 1) usually forms an interface which connects a network system 12 of computers to the display device 11 and to a print output device 13.

A hyper-text document formatter 14, preferably implemented as a software module on the general purpose computer, is operable to format a hyper-text document and controlled in part by instructions derived 15 from the hyper-text browser 10 responding to a user's request. Further, the hyper-text document formatter 14 communicates with the network system 12 to perform a multitude of functions including gathering, formatting, and collating documents with direct instructions from the hyper-text browser 10 or the user.

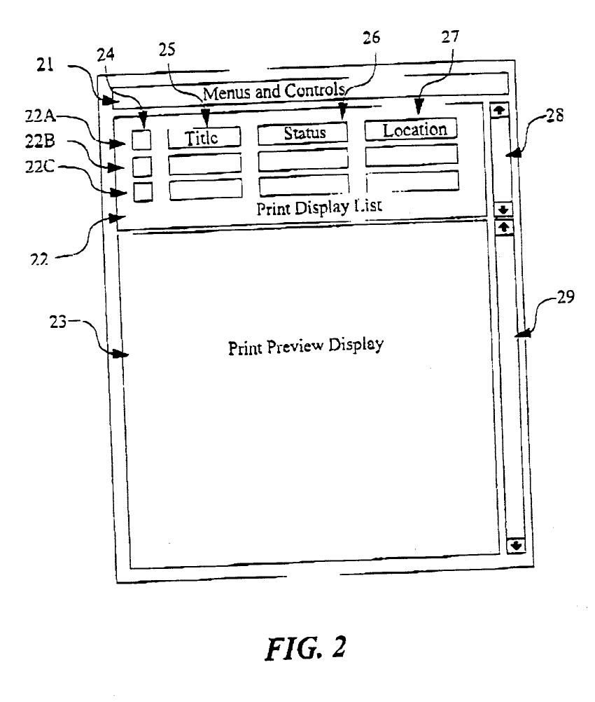

Referring to FIG. 2, there is shown a user interface layout of the preferred embodiment as displayed on the display device 11 and which comprises a menu and control area 21, a print list display 22, and a print preview display 23 The print list display 22 includes a list of print items 22A, 22B, 22C, each of which include a print item mark box 24, a hyper-text document title text field 25, a fetch status text field 26 and a location text field 27. The print list display 22 and the print preview display 23 are scrollable by means of scroll bar controls 28 and 28

The print preview display 23 displays (shows) representations) of the printed pages which are to be produced on the printer output device 13 using current selected print options, for example in a WYSIWYG (“what you see is what you get”) format. The user is free to select from the menu and controls 21 a print option other than the current print option. Such print option can include print settings for the print output device 13, portrait or landscape orientation of pages, print resolution and scaling. Upon user selection of an option, the current print preview display 23 is appropriately updated. However the display in the print preview display 23 is regenerated automatically as a current application state changes without intervention required by the user. Application states which can effect the print preview display 23 include, but are not limited to the currently selected printer, the currently selected paper type, formatting options which can be set by the operator, the set of marked items in a print list (ie. those selected by a mark in the print item mark box 24) and the order of marked items associated with the print list.

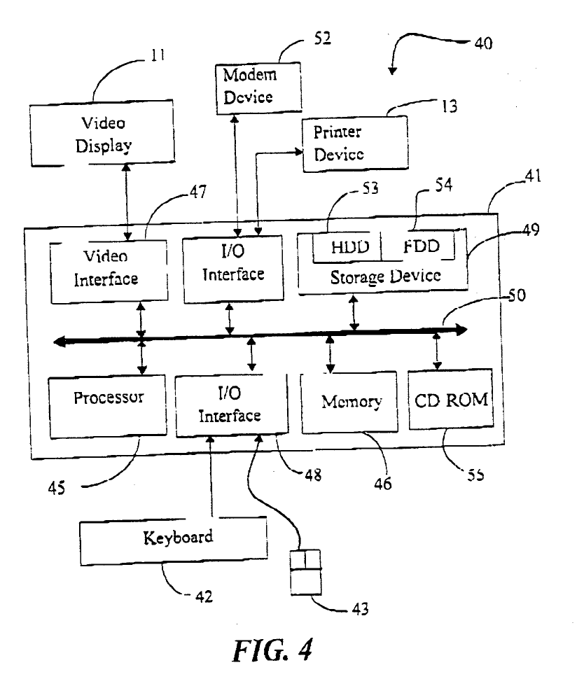

The preferred embodiment of the invention can be practised using a conventional general-purpose (host) computer system, such as the computer system 40 shown in FIG. 4, wherein the application program discussed above and to be described with reference to the other drawings is implemented as software executed on the computer system 40. The computer system 40 comprises a computer module 41, input devices such as a keyboard 42 and mouse 43, output devices including a printer 13 and a display device 11. A Modulator-Demodulator (Modem) transceiver device 52 is used by the computer module 41 for communicating to and from a computer network, for example connectable via a telephone line or other functional medium. The modem 52 can be used to obtain access to the Internet, and other network systems.

The computer module 41 typically includes at least one processor unit 45, a memory unit 46, for example formed from semiconductor random access memory (RAM) and read only memory (ROM), input/output (I/O) interfaces including a video interface 47, and an I/O interface 48 for the keyboard 42 a mouse 43 and optionally a joystick (not illustrated). A storage device 49 is provided and typically includes a hard disk drive 53 and a floppy disk drive 54. A CD-ROM drive 55 is typically provided as a non-volatile source of data. The components 45 to 49 and 53 to 55 of the computer module 41, typically communicate via an interconnected bus 50 and in a manner which results in a conventional mode of operation of the computer system 40 known to those in the relevant art. Examples of computers on which the embodiments can be practised include IBM-PC/ATs and compatibles, Sun Spacestations or alike computer systems. Typically, the application program of the preferred embodiment is resident on a hard disk drive 53 and read and controlled using the processor 45. Intermediate storage of the program and the print list and any data fetched from the network may by accomplished using the semiconductor memory 46, possibly in concert with the hard disk drive 53. In some instances, the application program may be supplied to the user encoded on a CD-ROM or floppy disk, or alternatively could be read by the user from the network via the modem device 52.

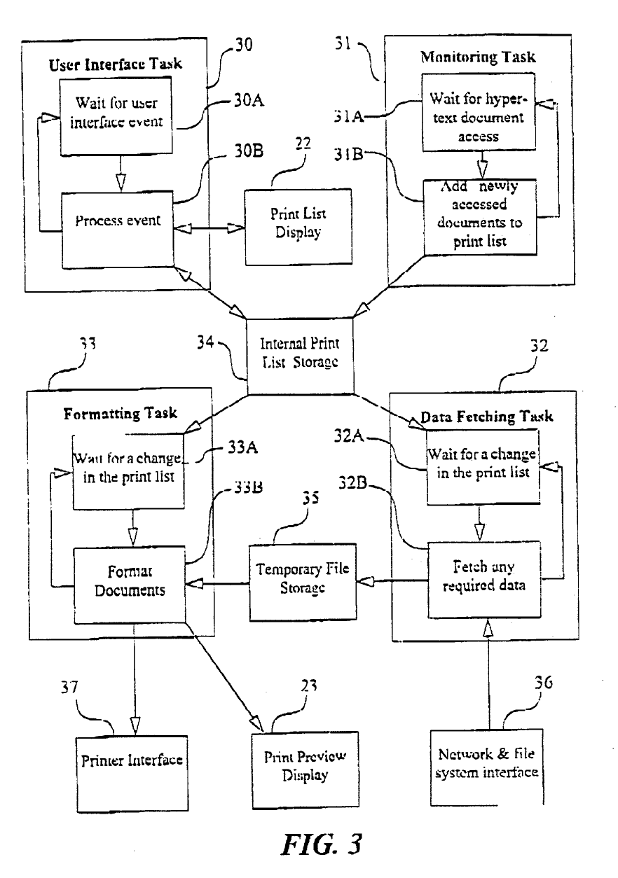

FIG. 3 shows a block diagram representation of an internal structure of the preferred embodiment, which comprises a user interface task 30, a monitoring task 31, a data fetching task 32, a formatting task 33, an internal print list storage 34, the print list display 22 (also shown in FIG. 2), the print preview display 23, a temporary file storage 35, a network and file system interface 36, and a printer interface 37.

The internal print list storage 34 is structured as a list of records in the memory 46 of the general purpose computer system 40, each record being referred to hereinafter as a “print item”. Each print item represents at least one hyper-text document, and comprises a Uniform Resource Locator (URL) by which the associated hyper-text document can be retrieved as well as a further list of records, each of which is referred to herein as a sub-item. Each sub-item represents a distinct file-like unit of data which is required to complete the formatting and displaying of the hyper-text document associated with the print item. These units of data (or sub-items) are most commonly hyper-text documents in HTML format and images in GIF or IPEG format. Each sub-item records a file name within the temporary file storage where the unit of data will be, or is, stored.

In FIG. 3, the four tasks 30, 31, 32, 33 are shown, each of which is implemented as a separate thread within a single application process. The internal print list storage 34 is shared by the tasks 30-33 in a manner to avoid conflicts. Each task 30-33 gains access to the print list on the internal storage 34 by first obtaining a “mutex” lock (mutually exclusive lock). Once the lock is obtained, the task leads and possibly modifies the print list and then releases the lock. Upon release of the lock, if changes were made to the print list, messages are forwarded to the user interface task 30, the formatting task 33 and the data fetching task 32 to inform them that changes have been made.

The user interface task 30 performs user interface operations by having a waiting state 30A and by acceptance of user interface events such as clicks and movements of the mouse 43, responds to process 30B as appropriate to each event. Operation of the task 30 is achieved by a message loop structure processing each operating system generated event in turn and is linked to the print list display 22.

The monitoring task 31 performs monitoring 31A of user initiated access to documents including hyper-text documents using the hyper-text browser 10, and entering 31B each such document accessed by the user into the print list. In particular, the browser 10 includes an application program interface (API) which allows viewing of information being cached by the browser 10. In this manner, the monitoring task 31 is able to take and maintain a record of the operation, typically sequential, of the browser 10. From the record, the print list 34 is automatically created using the URL's of the items located. The user is then able to edit the print list 34 by deselecting those items not required to be printed.

The fetching task 32 performs fetching of all documents which are listed in the print list along with associated data necessary for producing a visually pleasing (desired) or viewable formatted version of the documents in print form. Typically, the associated data includes print settings for a print devices to which the documents are to be directed. Operation of the fetching task 32 is preferably achieved through use of Internet protocols and/or network access techniques provided by the host operating system and includes a wait stage 32A for detecting any change in the print list, and a fetching stage 32B, for fetching the required data and storing the data in a temporary file storage 35 typically formed within the memory 46. The fetching task 32 is also responsible for initiating further fetches and amending the print list accordingly. Amending the print list or adding to the print list hyper-text pages which are hyper-linked from or of the pages previously fetched, by the fetching task 32, is typically performed as a background task to the hyper-text browser 10. Hyper-links previously visited by the fetching task 32 are preferably not re-visited to avoid repetition. The user may elect, as part of optional settings that the fetching task 32 visits, a predetermined number of hyper-link pages for augmenting the print list accordingly.

Preferably, the fetching task 32 provides a cross-referencing feature, should the user select or desire such option, which maintains a cross referencing to URL or hyper-links of hyper-text documents to be printed (formatted version) with an indexing of cross references and a corresponding page (number) in the document to be printed.

In this connection, the formatted version includes a table of contents listing each hyper-text document represented in the document to be printed. Each entry in the table of contents is labelled with the position (page number) at which the associated hyper-text document occurs within the said formatted version.

The formatting task 33 performs formatting of all documents which are listed in the print list in a manner suitable for printed output, and also optionally showing a preview of the printed output which would be produced in the print preview area. Its operation is achieved by a recursive descent HTML/parser and formatter, and results from waiting 33A for a change in the print list, and a format stage 38B which formats the documents forwards it to a printer interface 37 for hard copy reproduction.

Notwithstanding that the updating of the print preview display 23 appears, under some circumstances, to depend on an availability of a hyper-text document through the network, a substantial portion of the tasks described with reference to FIG. 3 are performed substantially instantaneously in background mode unbeknown or at least not immediately apparent to the user. Typically, the tasks 30-33 can be performed synchronously or asychronously with a user's access pattern. Usually, a user accesses or visits, with the aid of the browser application, root hyper-text documents. Described in an alternative way, hyper-text documents visited by a user are referred to herein as root hyper-text documents, and any further hyper-links and their associated documents are visited and fetched by the fetching task 32 respectively. The depth to which hyper-links are followed in fetching hyper-text documents is user defined. Preferably, all hyper-links, of a root hyper-text document having predetermined characteristics are visited by the fetching task 32 and the associated (hyper-text) documents are retrieved. For example, a user may mark hyper-links to be followed to a predetermined depth or the user may specify characteristics of hyper links, and their associated documents, to be all documents descendent from a current root hyper-text document containing predetermined keyword.

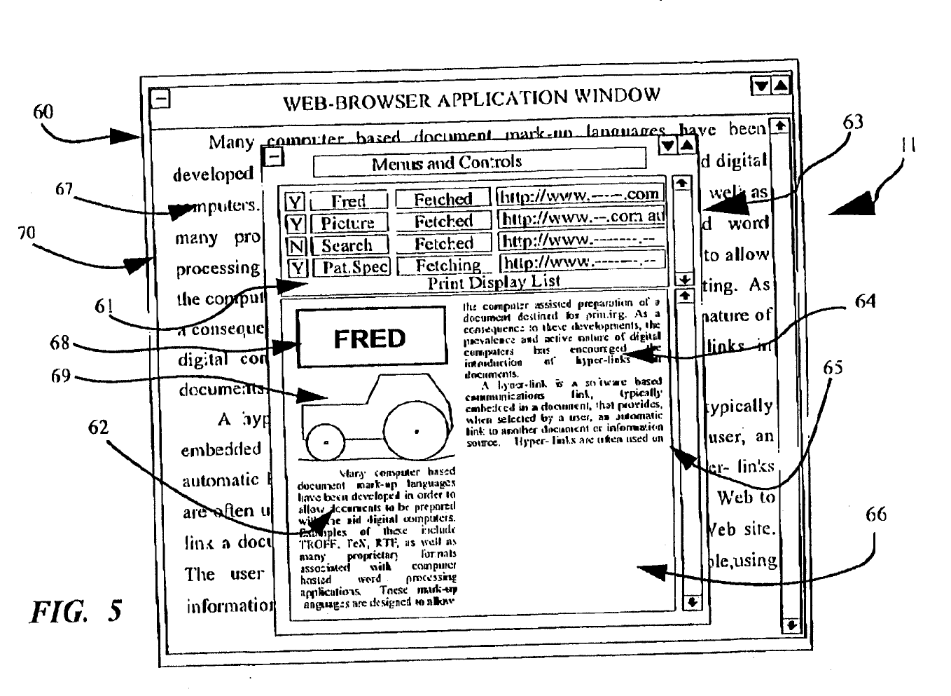

FIG. 5 provides an illustrative representation of the preferred embodiment use. FIG. 5 shows a display screen 60 of the display 11 which has two windows clearly displayed. A window 70 is a web-browser application window that displays a text document 67 (corresponding to a few of the introductory paragraphs of this patent description). This forms a background window and is representative of the hyper-text browser application 10 covering the entire screen area. Superimposed on top of the window 70 is a window 63 corresponding to a working display of the application program of the preferred embodiment, described earlier with reference to FIG. 2. The user in this case is preparing a document formed from three sources, each mentioned in the print display list 61. A first source 68, called FRED, is a simple text source previously encountered during a Web review, and occupies a first position in the document being formed. A second source 69, being a picture of a vehicle, occupies a second position, whilst a third source, corresponding to the background text document 67, occupies the third position. It is seen from the print display list that a Search engine, used to locate the text document 67 has been de-selected (N—No) from display, and hence does not appear in the WYSIWYG print preview 65. The display list indicates that each source has been fetched is its corresponding URL, and is selected (Y—Yes) for display. In each case the location identifier provides the Web site address for the source material.

As seen in FIG. 5, the second column 64 of the print preview 65 has a blank section 66 As seen from the print display list 61, the text document 67 remains in a “fetching” state, where the text is being retrieved and formatted for WYSIWYG display. Once this is completed, the section 66 displays the text that has since been fetched and the print display list 61 is updated to indicate a “fetched” status for that document.

In compiling the print document, the application program, and in particular, the document formatter 33B, recognises that the width of FRED and the picture are narrower than the page, and therefore establishes a column corresponding to their width. Because of its length, the text document 67 is formatted, firstly into a narrower, left hand column 62 related to the width of FRED 68 and the picture 69, and then to flow into the right hand column 64 which is adjusted to a width to substantially fill the page. Importantly, the application program is configured to automatically detect the selected content of a source, and to incorporate that content into the print preview display 23 (65) in an economical manner so that as many hyper-text documents as can reasonably be fitted to a page can be displayed. This reduces paper consumption.

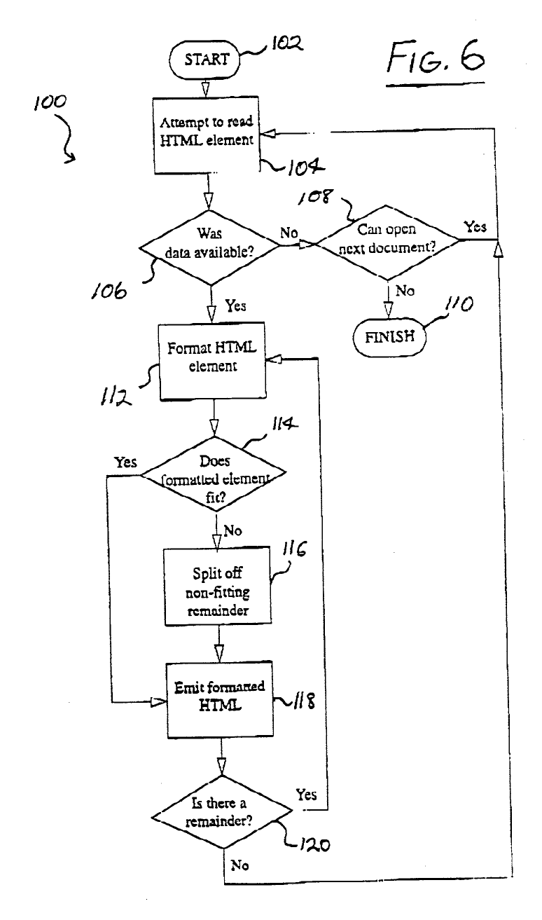

The preferred embodiment is configured to operate in background mode whilst the user is traversing the World Wide Web to automatically create and format a printable document representing a chronological history of the user's traversal of the World Wide Web. Typically, the preferred embodiment operates in a background mode as a window operating behind a web browser window. As seen in FIG. 6, a flowchart of procedures 100 of the hyper-text document formatting portion of the preferred embodiment commences at a starting point 102. This entry point leads to a step 104 where the application attempts to read an HTML element from a Web document currently being viewed using a Web browser program. At step 106, which follows step 104, an assessment of data availability is made and if none is available, step 108 assesses whether or not another document can be opened. If so, control is returned to step 104 for handling the new document. If not, document formatting is completed at step 110.

If data is available at step 106, control is passed to step 112 where the HTML element of the current Web site location is formatted into a standard form able to be printed using the application program. At step 114, an assessment is undertaken as to whether or not the formatted element is able to fit on to the page to be printed. If so, control is transferred to step 118 where the formatted HTML document is emitted as an output document. If the formatted element does not fit on to the page as determined by step 114, control is passed to step 116 which splits off or culls, the non fitting remainder of the formatted element. This enables control to be passed to step 118 for omitting of the remaining formatted HTML document. After step 118, control is passed to step 120 which assesses whether or not there is a remainder, for example left over from step 116. If so, control is returned to step 112 so that the remainder can be formatted and processed in the manner described above. If there is no remainder, control is returned to step 104 in order to read the next HTML element.

With the arrangement described in FIG. 6, whilst the user browses the World Wide Web, the application program continually assesses the data being viewed in the browser window and automatically formats that data into a continuous printable document displayed in the window for example shown in FIGS. 2 and 5. When the user has completed browsing, the window of the application program (ie. window 63 of FIG. 5). can he selected. Using the print display list 61, the user can either select or deselect certain documents located during the Web browsing session for printing. During the course of a browsing session, all documents seen are automatically enabled in the print document window. Accordingly, prior to printing all that is necessary is for the user to cull out or deselect those components not desired for printing. For example, if the user had made use of a search engine during the Web browsing session, there may be little point in printing out the text associated with that search engine. All that would be necessary to print could be the actual document or Web site location found as a result of the search, such as shown in the example of FIG. 5.

A further advantage of the present invention is that, in the printed document, at the completion of each session relating to an individual Web location, the actual Web location is printed onto the printed document so that the user has a permanent hard copy record of not only the information sourced but of the location of that source.

The foregoing only describes one embodiment of the present invention, however, modifications and/or changes can be made thereto by a person skilled in the art without departing from the scope of the invention.

We claim:

1. A method of collating hyper-text documents, said method comprising the steps of:
(a) monitoring a user's access patterns to said hyper-text documents; and
(b) accessing said hyper-text documents including structure information of the accessed hyper-text documents;
(c) creating a formatted version of the accessed hyper-text documents for said user

2. A method as claimed in claim 1, wherein steps (a), (b) and (c) are conducted while the user accesses hyper-text documents.

3. A method as claimed in claim 1, wherein said formatted version of the accessed hyper-text document is updated upon new hyper-text pages being accessed.

4. A method as claimed in claim 1, wherein said steps are performed in background mode.

5. A method as claimed in claim 1, wherein steps (b) and (c) are performed asynchronously with a user's access to said hyper-text documents.

6. A method as claimed in claim 1, wherein said steps are performed substantially in synchronism with a user's access to said hyper-text documents.

7. A method as claimed in claim 1, wherein said formatted version is formatted to be suitable for single or multiple column page printing on a printer output device.

8. A method as claimed in claim 7, wherein said formatted version suitable for single or multiple column page printing comprises as many hyper-text documents on each printed page as can reasonably fit in a space available on said each printed page.

9. A method as claimed in claim 1, wherein said formatted version includes a table of contents listing each hyper-text document represented in said formatted version wherein each entry in the said table of contents is labelled with the position at which the associated hyper-text document occurs within the said formatted version.

10. A method as claimed in claim 1, wherein said formatted version includes a hyper-link index of all the hyper-link references in all the said hyper-text documents represented in said formatted version.

11. A method as claimed in claim 10, wherein each hyper-link reference in the said formatted version is tagged with a cross-reference to its entry in said hyper-link index.

12. A method as claimed in claim 10, wherein said hyper-link index excludes hyper-link references of hyper-text documents represented in said formatted version.

13. A method as claimed in claim 1, wherein the said hyper-text documents are HTML documents.

14. A method as claimed in claim 1, wherein the said hyper-text documents are accessed using Internet protocols.

15. A method as claimed in claims 1, wherein said formatted version is displayed in preview form continuously while said user accesses said hyper-text documents.

16. A method of collating hyper-text documents, said method comprising steps of:
(a) accessing said hyper-text documents including structure information;
(b) creating a formatted version of said accessed hyper-text documents wherein said formatted version is characterised by a single or multiple column printing such that each printed page contains as many of said hyper-text documents as can reasonably fit in an available space on a printed page.

17. A method as claimed in claim 16, wherein said hyper-text documents are determined by accepting a specification from a user of one or more root hyper-text documents and adding to said root hyper-text documents all derived hyper-text documents which are hyper-linked from said root hyper-text documents and have certain specified characteristics defined by said user.

18. A method as claimed in claims 16, wherein said formatted version includes a table of contents listing each hyper-text document represented in said formatted version wherein each entry in the said table of contents is labelled with the position at which the associated hyper-text document occurs within the said formatted version.

19. A method as claimed in claim 16, wherein said formatted version includes a hyper-link index of all the hyper-link references in all the said hyper-text documents represented in said formatted version.

20. A method as claimed in claim 16 wherein each hyper-link reference in the said formatted version is tagged with a cross-reference to its entry in said hyper-link index.

21. A method as claimed in claim 16, wherein said hyper-link index excludes hyper-link references of hyper-text documents represented in said formatted version.

22. A method as claimed in claim 16, wherein the said hyper-text documents are HTML documents.

23. A method as claimed in claim 16, wherein the said hyper-text documents are accessed using Internet protocols.

24. A method as claimed in claims 16, wherein said formatted version is displayed in preview form continuously while said user accesses said hyper-text documents.

25. Apparatus configured to implement the method of claim 1.

26. Apparatus configured to implement the method of claim 16.

27. A computer implemented method for collating a plurality of documents obtained from a plurality of sources, said method comprising the steps of:
monitoring accesses to documents in sequence;
recording the contents of a plurality of selected documents including structure information relating to each said selected document; and
collating said selected documents according to a predetermined order of collation, said collation comprising arranging none or more display pages according to the sizes of each said selected document based upon said corresponding structure information, wherein said collating forms a single document reproducible at least by printing.

28. A computer system comprising:
a network comprising a source of a plurality of documents each individually accessible via a resource locater, wherein ones of said documents include therein links that give access to others of said document;
means for monitoring, said resource locater and compiling a display list of said documents, said list including the corresponding links and structure information pertaining to each document; and
means for collating the display list into a selected order and for formatting said documents within said display list into a single printable document having corresponding components arranged in said selected order.

30. A computer readable medium including instruction modules arranged to collate for printing as a single document a plurality of documents derived from a plurality of sources in a network, said modules comprising:
a monitoring module for monitoring browsing operations throughout said network.
a compiling module for compiling a display list of selected documents encountered during said browsing operations; and
a collating module for collating the selected documents into a single printable document in which each said selected document in formatted according to structure information derived during said monitoring module whereby said single printable document is collated to be substantially seamless in printing reproduction and to minimize vacant or wasted space on any and each printed page.

31. A medium as claimed in claim 30 wherein said medium is one of a computer network, a hard disk, a floppy disk and an optical disk.

32. A computer program product having a computer readable medium having a computer program recorded thereon for collating hyper-text documents, said computer program product comprising:
means for monitoring a user's access patterns to said hyper-text documents;
means for accessing said hyper-text documents including structure information of the accessed hyper-text documents; and
means for creating a formatted version of the accessed hyper-text documents for said user.
